(19) United States
(12) Patent Application Publication
(10) Pub. No.: US 2016/0029782 A1
(43) Pub. Date: Feb. 4, 2016

(54) SILICONE SNOW BRUSH

(71) Applicant: SINA MOGHBEL, Vaudreul-Dorion (CA)

(72) Inventor: SINA MOGHBEL, Vaudreul-Dorion (CA)

(21) Appl. No.: 14/711,389

(22) Filed: May 13, 2015

Related U.S. Application Data
(60) Provisional application No. 61/992,943, filed on May 14, 2014.

(51) Int. Cl. A46B 15/00; B60S 3/04

(52) U.S. Cl. CPC A46B 15/0081; B60S 3/045

(57) ABSTRACT

A silicone snow brush made of a head portion comprising of an array of silicone bristles set into a handle portion for removing snow from the surface of a vehicle. Attached to the handle portion are a hand grip and an ice scraper.

### FIELD OF THE INVENTION

The present invention relates to brushes for removing snow and ice, mainly from surface of a vehicle, side windows, front and rear windshields. More specifically, the present invention is concerned with a snow brush made of a head portion comprising of an array of silicone bristles set into a handle portion having a hand grip and an ice scraper attached at the opposite end of the handle.

### BACKGROUND OF THE INVENTION

A snow brush is most commonly used to remove snow from the surface of the car, windshields and side windows. The ice scraper is used to remove ice from windshields and side windows. A snow brush is made of a stiff handle which may be made of wood, plastic or aluminum that is attached to a head having an array of plastic bristles thus forming a brush at one end and ice scraper attached at the opposite end. Where there is a need to brush the snow or scrape the ice from the surface of a vehicle, the user can do this simply by reversing their grip of the handle.

A snow brush having plastic bristles presents disadvantages in both use and storage. Because of the rough nature of plastic bristles, it is difficult to avoid scratches on a vehicle's paint every time the brush is used to remove the snow from the body of the vehicle. Over the span of a winter, this will result in multiple scratches on the paint of the vehicle.

Problems associated with storage of a non-silicone brush arise from accumulation of snow in the bristles. When a non-silicon brush is placed for storage in an area such as the interior of an automobile where the temperature is above zero degrees centigrade, any amounts of snow accumulated in the bristles tend to melt and the water often leak onto the surface beneath the brush. This is particularly problematic when storing the brush inside an automobile. Common storage areas in automobiles are the trunk or the floor inside the vehicle, areas that are usually covered in upholstery. Over time, the accumulation of dirt and water onto the upholstery can cause discolouration and may lead to the development of rust on the underlying body of the vehicle.

The present invention overcomes the disadvantages associated with brushes having non-silicon bristles, by replacing plastic bristles with a head comprising of an array of silicone bristles. A brush having silicone bristles is non-abrasive, allowing for scratch-free snow removal. The non-absorbent nature of the silicone bristles makes is easier to shake off the snow, leaving little or no water within the bristles for storage.

### SUMMARY OF INVENTION

The present product provides a snow removal brush made up of a handle and a head portion comprising of an array of silicone bristles such that when used, the non-abrasive nature of the silicone brush does not scratch the paint on the car often associated with the use of non-silicone brushes. The said silicone bristles do not allow for heavy water accumulation, therefore also minimizing damages cause by dirt and moisture on the vehicle's upholstery. The handle portion has a hand grip for comfort and ease of use. The handle also has an ice scraper for removing ice from the windows of the vehicle.

### BRIEF DESCRIPTION OF THE DRAWINGS

For the purpose of aiding an understanding of the invention sought to be protected, the accompanying drawings illustrate by way of example only a preferred embodiment of the said invention.

FIG. 1 is a diagonal view of the preferred embodiment of the silicone snow brush.

FIG. 2 is a side elevation view of the preferred embodiment of the silicone snow brush of FIG. 1.

FIG. 3 is a plan view of the preferred embodiment of the silicone snow bush of FIG. 1.

FIG. 4 is an enlarged fragmented view of the silicone snow brush bristles of the preferred embodiment of FIG. 1.

### DETAILED DESCRIPTION OF THE INVENTION

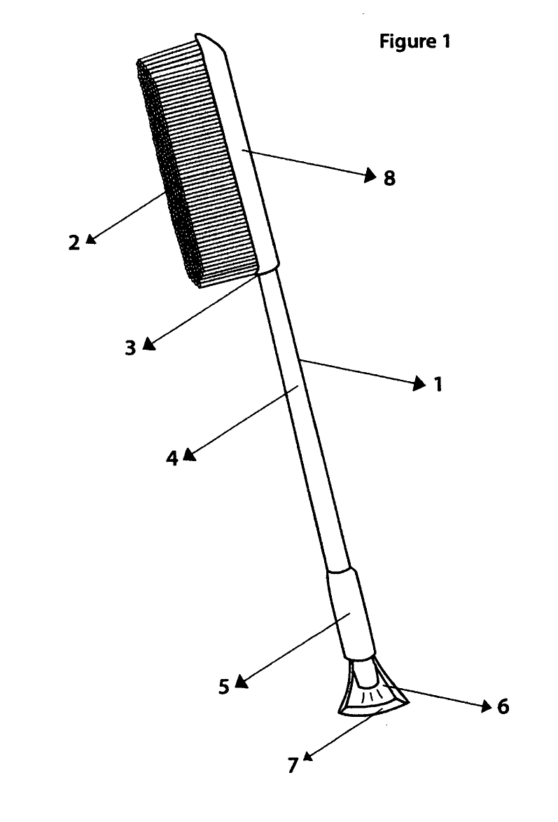

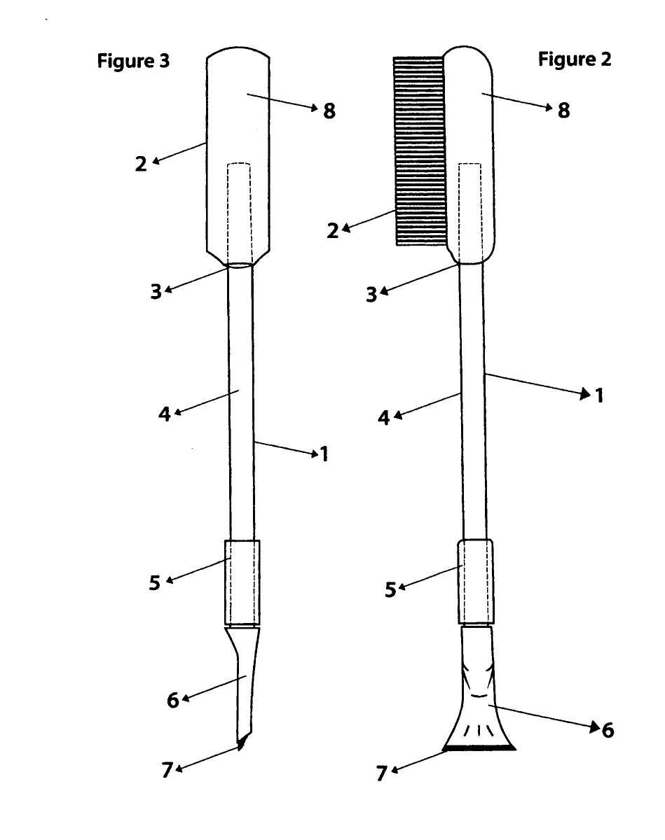

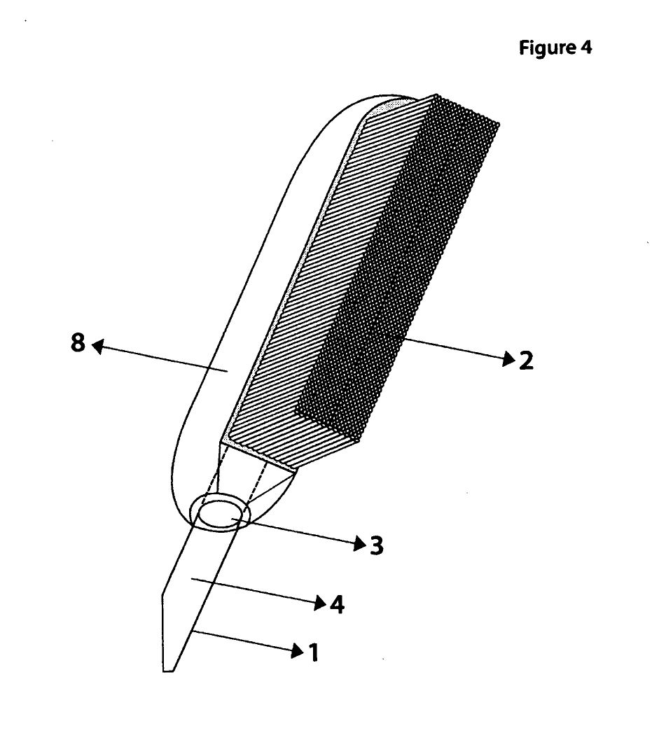

In a preferred embodiment of the present invention, as illustrated in FIG. 1 of the appended drawings, a silicone snow brush 1 comprising a head portion 8 and a handle portion 4. The handle portion 4 sets into the head portion 8 through the opening 3 shown in FIG. 4 of the appended drawings. Attached to the opposite end of the handle 4 are a hand grip 5 and an ice scraper 6 having a sharp edge 7, the head portion 8 comprising of an array of silicone bristles 2.

An improvement provided by the present invention consists of replacing conventional plastic bristles along the head portion 8, with silicone bristles 2. The silicone bristles 2 are non abrasive and as such do not leave surface marks after use. Silicone bristles are more flexible than plastic bristles but are rigid enough to remove snow from the surface of a vehicle. Furthermore, silicone is a non absorbent material and therefore easier to shake off any amount of snow which may accumulate in the bristles 2. The silicone bristles 2 extend along the periphery of the head portion 8 as shown in FIG. 4 of the appended drawings. The silicone bristles brush 1 has an opening 3 in the head portion 8, whereby the handle portion 4 sets into head portion 8 as shown in FIG. 4 of the appended drawings. The handle portion 4 may be made of light durable material such as plastic or aluminum. Attached to the handle portion 4, at the opposite end from the head portion 8 are a hand grip element 5, and an ice scraper 6 as illustrated in FIG. 3 of the appended drawings. The hand grip 5 provides comfort and facilitate grip during use in cold weather. The scraper 6 having a sharp edge 7, shown in FIG. 3 of the appended drawings, facilitates scraping ice from the side windows and windshields of a vehicle.

The above provides a description by way of example only a preferred embodiment of the invention. Various changes may be made in the details of the invention without departing from the basic invention or the scope of the appended claims.

1. A snow brush having:
a handle portion;
a head portion connected to the handle portion;
a hand grip element located between the head portion and the ice scraper portion, near the ice scraper;
an ice scraper having a sharp edge connected to the opposite end of the handle portion;
the head portion comprising of an array of silicone bristles.
